(19) United States
(12) Patent Application Publication
(10) Pub. No.: US 2015/0308244 A1
(43) Pub. Date: Oct. 29, 2015

(54) METHODS AND SYSTEM FOR CONTROLLING A LINEAR MOTOR FOR A DEEP WELL OIL PUMP

(71) Applicant: MOOG INC., East Aurora, NY (US)

(72) Inventors: David P. Cardamone, Lansdale, PA (US); Carl Deirmengian, Media, PA (US); Eugene F. Keohane, Springfield, PA (US); Benjamin W. Kinnaman, Jericho, VT (US)

(21) Appl. No.: 14/646,970

(22) PCT Filed: Nov. 26, 2013
(86) PCT No.: PCT/US2013/071976

§ 371 Date: May 22, 2015

Related U.S. Application Data
(60) Provisional application No. 61/729,815, filed on Nov. 26, 2012.

(51) Int. Cl. E21B 43/12; G05B 15/02

(52) U.S. Cl. CPC E21B 43/128; G05B 15/02

(57) ABSTRACT

A deep well linear motor pump system (122) comprising a downhole linear electric motor (222) having a stator and a shaft configured to move linearly relative to the stator, a downhole pump (220) having an inlet (227), an outlet (228), and a piston coupled to the linear motor shaft, a motor driver system (318) connected with the linear motor and configured to provide drive commands to the linear motor, a surface control computer (126) connected with the motor drive system and configured to control the linear motor, a sensor system (224) communicating with the control computer and configured to sense operating parameters of the linear motor, and the sensor system comprising a synchronous serial interface encoder configured to sense position of the motor shaft and a temperature sensor configured to sense the temperature of the motor.

### TECHNICAL FIELD

The present invention relates generally to the field of oil and gas wells, and more particularly to a downhole linear motor pump system.

### BACKGROUND ART

U.S. Pat. No. 1,655,825 is directed to a linear electromagnetic motor coupled to an oil well pump. Solenoids are mounted within a casing and arranged to actuate a core of stacked magnets interspersed between non-magnetic members. The core is coupled to a pump plunger and an upper valve and two lower valves allow only upwards flow of fluid.

U.S. Pat. No. 5,049,046 is directed to a downhole electromagnetic motor-pump assembly having a linear motor, a pump having a reciprocating piston, and a remote wireless monitoring station.

U.S. Pat. No. 5,831,353 is directed to a motor-pump assembly having a positive displacement pump and a motor for driving the pump to allow the fluids in the production tube to be lifted to the upper ground level. A controller is provided for controlling the linear motor and supplies the motor with a certain number of direct current pulses.

### BRIEF SUMMARY OF THE INVENTION

With parenthetical reference to the corresponding parts, portions or surfaces of the disclosed embodiment, merely for the purposes of illustration and not by way of limitation, provided is a system (110) for operating a downhole pump with a linear motor, including a pump system (122), a motor drive system (124), a control and communication computer system (126), and a power distribution system (128). The control computer system, motor drive system, and power distribution system may be contained in an environmental protection box (125). The system may include a GUI computer (130), a data server (134), and a remote management computer (138).

The pump system may include a linear motor (222), a pump (228), and a motor sensor package (224). The motor sensor package may include an SSI encoder position sensor, a motor temperature sensor, an inclinometer, and a fault sensor. The pump may include an inlet (227) and the inlet may have a temperature sensor (225) and a pressure sensor (226). The pump may also have an outlet (231), and the outlet may have a pressure sensor (229). The motor may receive power from a three phase motor power line (234). The motor sensor package may be connected to the control computer through a three twisted pair connection (237). The inlet and outlet pressure sensors and temperature sensor may be connected to the control computer through a line (239) which uses a transducer.

The motor drive system (124) may include a motor drive unit (318) and a SINE filter (321). The motor drive unit may be configured and arranged to receive and transmit transducer twisted pair lines from the pump system. The motor drive unit may support a field bus interface (326). The field bus interface may include DeviceNet, RS485, F-NET, Modbus, FireWire, CANopen, Ethernet IP, ProfiNet, SERCOS, 12-bit Analog IN, 16-bit Analog I/O, and/or other similar bus hardware and protocols.

The control and communication computer system may include a router (419), a switch (421), a wifi access port (141), GSM modem (145), a satcom modem or port (143), and a single board computer (410). The control computer may include an Ethernet (423) for linking each of its components. The single board computer may include a PC-104 single board computer or other embedded computer. The single board computer may have an I/O (425), a GPS (427), a CPU (429), a memory (431), and a power supply (433). The control computer system may include an RS-485 transducer interface (435) for communication.

The control and communication computer may have a control algorithm for controlling the motor drive system, and/or pump system. The control algorithm may control the motor drive system and/or pump as a function of sensory data. The sensory data may be data from the pump system, the motor drive system, the power distribution system, and/or the data server. The control algorithm may be capable of recognizing several dyna card operating regimes and/or may be configured to adjust control of the motor drive as a function of recognizing dyna card operating regimes. The dyna card operating regimes may include bent or sticking barrels, worn or sticking barrels, severe gas compression, gas compression, gas locked pump, severe traveling valve leak or plunger leak, severe standing valve leak, leaking traveling valve or plunger, severe standing valve leak, or a combination of leaking standing and traveling valve and gas compression. Dyna card operating regimes may further include tubing movement, fluid pound, pump hitting, upstroke pump wear, worn standing valve, worn or split barrel, fluid friction, and/or drag friction.

The power distribution system may include a three phase AC power input, and may provide an AC power output and a DC power output. The power distribution system may include one or more circuit breakers (521, 523), a surge suppression unit (522), a transformer (524), a MOV suppression unit (525), and a fuse terminal distribution block (526). The power distribution system may further include a cooling thermostat (537), a cooling fan or air conditioner (539), a heat thermostat (541), a heater relay (528), and/or a heater (529). The power distribution unit may further include an auxiliary power outlet (530). The power distribution unit may be configured and arranged to automatically keep the environmental protection box at a temperature within a predetermined temperature range.

The GUI computer may contain a software application (131) for allowing a user (101) to view sensor data, and view and set control computer operating parameters and algorithms. The data server may contain a web application (136) for allowing a user (102) to link with a remote management computer (138) and allow user (102) to view sensor data, and view and set control computer operating parameters. The data server may contain a database for storing sensor data from the control computer. The sensory data may be periodically transferred from the control computer to the data server. The data server may also be configured to periodically transmit secondary operating parameters to the control computer. The secondary operating parameters may include the price of oil, and the price of electricity. The data server may be configured and arranged to operate a number of pump systems.

### BRIEF DESCRIPTION OF THE DRAWINGS

FIG. 1 is a system block diagram of a first embodiment system.

FIG. 2 is a block diagram of the pump system shown in FIG. 1.

FIG. 3 is a block diagram of the motor driver system shown in FIG. 1.

FIG. 4. is a block diagram of the control and communication computer shown in FIG. 1.

FIG. 5 is a block diagram of the power distribution system shown in FIG. 1.

FIG. 6. is a model schematic of the containment box of the system shown in FIG. 1.

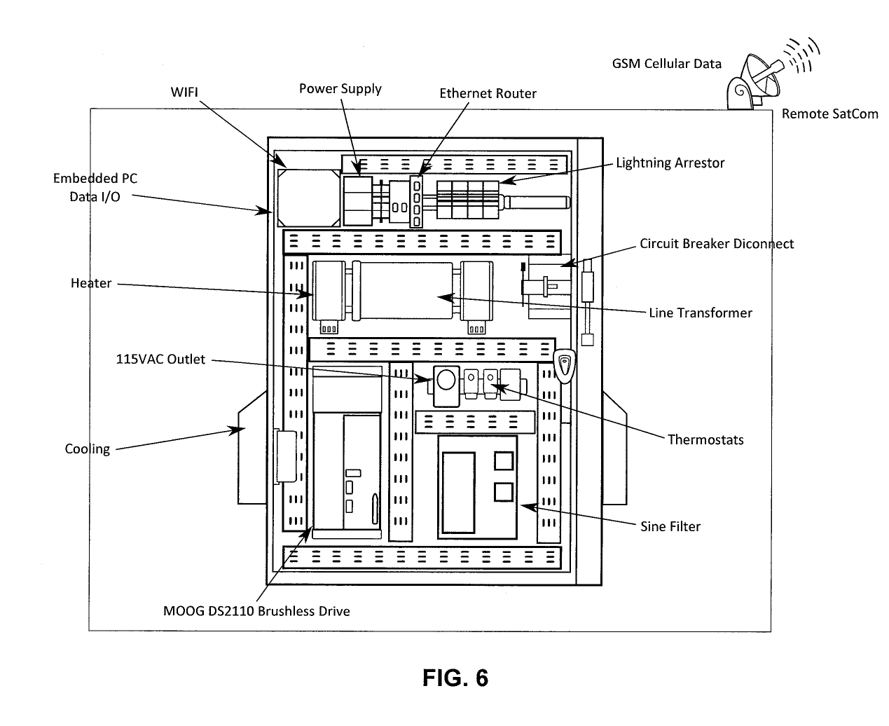

FIG. 7 is a chart of dyna card pump operating regimes.

FIG. 8 is a second chart of dyna card pump operating regimes.

### DETAILED DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

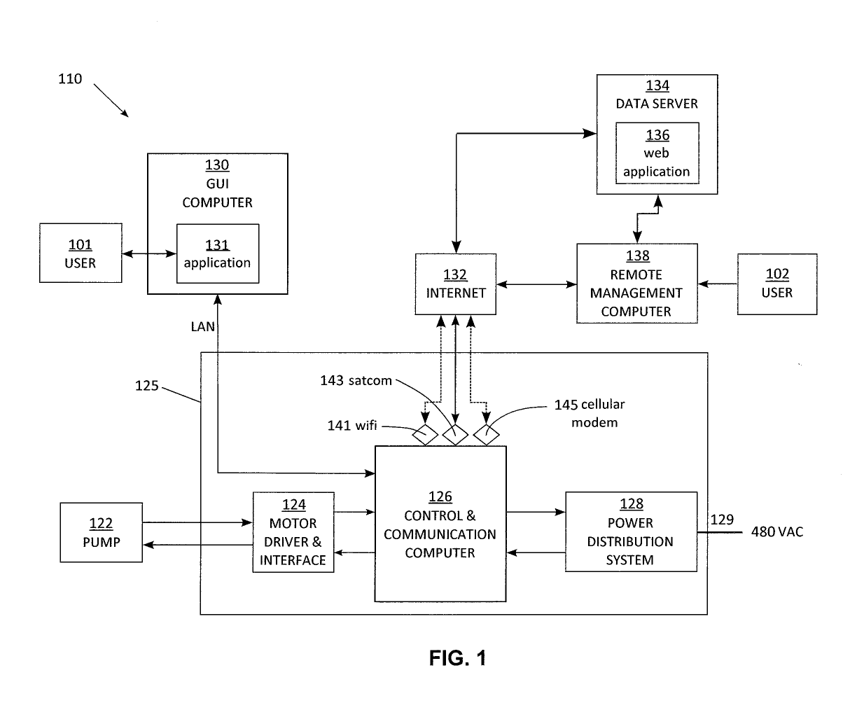

Referring now to the drawings, and more particularly to FIG. 1, a system for operating a deep oil well pump with a linear motor is provided, a first embodiment of which is generally indicated at 110. System 110 generally includes deep well pump system 122, motor driver 124, control and communication computer 126, and power distribution system 128. Also part of system 110 are GUI computer 130, data server 134, and remote management computer 138. Pump system 122 is driven by motor driver & interface 124. Control and communication computer 126 provides motor driver 124 with command signals to properly drive pump system 122. Control and communication computer 126 also contains communication systems for interacting with data server 134 and GUI computer 130. Control and communication computer 126 stores and relays sensory data from pump system 122 and driver 124 to data server 134 and/or GUI computer 130. GUI computer 130 provides user 101 a user interface for reviewing sensory data and setting operational parameters of control and communication computer 126. Data server 134 includes web application 134 which provides an interface to remote management computer 138. Through interaction via web application 136, remote management computer 138 provides user 102 with a user interface for reviewing sensory data and setting operational parameters of control and communication computer 126. Data server 134 also acts as a data storage for sensory data received from control and communication computer 126. Motor driver and interface system 124, control and communicating computer system 126, and power distribution system 128 may all be contained in a common box or cabinet 125 designed to provide protection from the surrounding environment.

System 110 provides high level and detailed remote control of deep oil well pump system 122 with numerous features for highly efficient and safe operation. Pump system 122 is arranged near the bottom of a deep oil well and has the primary purpose of pumping oil up to the surface of the oil well. Pump system 122 includes a linear electromagnetic pump motor. Pump system 122 contains several sensors for monitoring pump operation and deep oil well conditions. Pump system 122 is connected to motor driver and interface 124.

Motor driver 124 provides pump system 122 with the high powered power lines for driving the linear electromagnetic motor. Motor driver and interface 124 also contains data lines for relaying sensory data from pump system 122 and motor driver and interface 124 to control and communication computer 126.

Control and communication computer 126 contains a real time controller/CPU for providing motor driver 124 with the proper gate drive signals for operating pump system 122 with a desired movement profile. Computer 126 is arranged at the surface of the deep oil well. Control and communication computer 126 includes data sampling and storage mechanisms for receiving and storing sensory data from both pump system 122 and motor driver 124. Additionally, control and communication computer 126 includes communications transceivers including wifi modem 141, satellite modem 143, and cellular data modem 145. The communications transceivers provide a network link to data server 134. Control and communication computer may also optionally have a wired network connection to a network for connection to data server 134. Control and communication computer 126 includes data storage for storing operational parameters as well as sensory data logs. Control and communication computer 126 provides a local area network (LAN) for interfacing with GUI computer 130.

Power for computer 126, and motor driver 124 is provided by power distribution system 128. Power distribution system converts a high voltage AC voltage from a supply line into lower regulated voltage for computer 126 and motor driver 124. Power distribution system 128 includes transformers, filters, and monitoring sensors and protection devices. Sensory data is provided from power distribution system 128 to control and communication computer 126. Power distribution system 128 also receives control signals from control and communication computer 126.

GUI computer 130 may be a portable computer brought by a service user 101 in order to provide on-site maintenance and/or monitoring. Alternatively, GUI computer may be a desktop computer arranged and kept at the deep oil well surface in proximity to control and communication computer 126. GUI computer 130 interfaces to control and communication computer 130 through a LAN provided by computer 126. GUI computer 130 generally includes a display for providing user 101 a graphical user interface for viewing system operational data. Operational data includes sensory data from pump system 122, motor driver 124, power distribution system 128, and control and communication computer 126. GUI computer 130 also provides user 101 with a mechanism for changing operational parameters of control and communication computer 126.

Data server 134 is a server computer arranged at a location remote from the oil well. Data server 134 is connected to network 132 which is linked to control and communication computer 126 through one of a variety of communication link types, including hardwire connection, or internet connection via wire, wifi, satellite modem, and/or cellular data connections. Data server receives sensory data logs from control and communication computer 126. Data server 134 contains web server/web application 136 for providing a client interface for viewing the sensory data logs on remote management computer 138. Web application 136 also provides a mechanism for setting the control parameters on control and communication server 126.

While certain types of computers are described herein, processing and analysis may be practiced with different computer configurations, including internet appliances, hand-held devices, wearable computers, multi-processor systems, programmable consumer electronics, network PCs, mainframe computers, a system on a chip, or a programmable logic device such as a FPGA (field programmable gate array) or a PLD (programmable logic device). Various alternative memory devices may be included with the computer, such as flash memory, a hard disk drive, or other solid state memory device. The programming can be embodied in any form of computer-readable medium or a special purpose computer or data processor that is programmed, configured or constructed to perform the subject instructions. The term computer or processor as used herein refers to any of the above devices as well as any other data processor. Some examples of processors are microprocessors, microcontrollers, CPUs, PICs, PLCs, PCs or microcomputers. A computer-readable medium comprises a medium configured to store or transport computer readable code, or in which computer readable code may be embedded. Some examples of computer-readable medium are CD-ROM disks, ROM cards, floppy disks, flash ROMS, RAM, nonvolatile ROM, magnetic tapes, computer hard drives, conventional hard disks, and servers on a network. The computer systems described above are for purposes of example only. An embodiment of the invention may be implemented in any type of computer system or programming or processing environment. In addition, it is meant to encompass processing that is performed in a distributed computing environment, were tasks or modules are performed by more than one processing device or by remote processing devices that are run through a communications network, such as a local area network, a wide area network or the internet. Thus, the term computer is to be interpreted expansively.

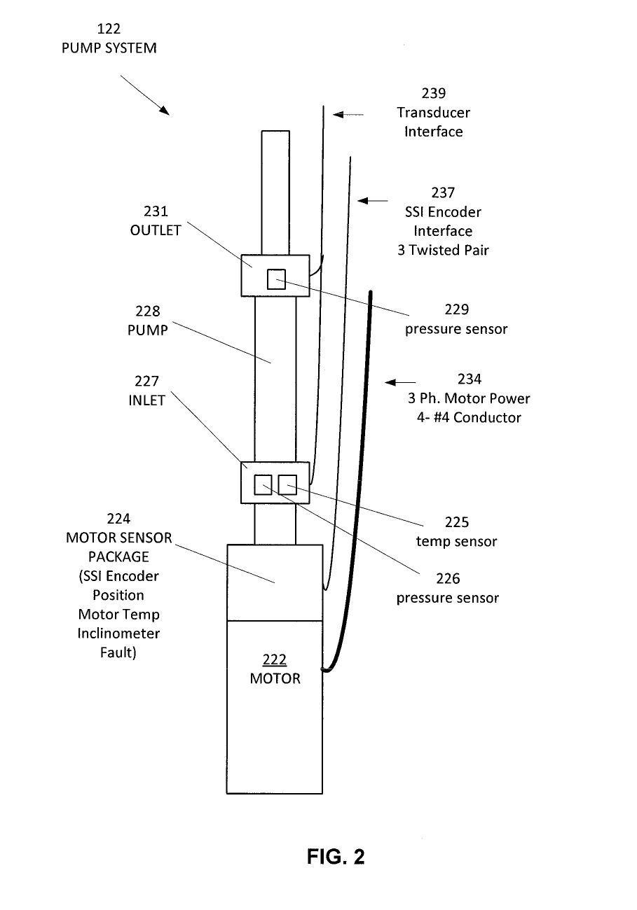

FIG. 2 is a block diagram of pump system 122. Pump system 122 includes motor 222 arranged near the bottom of an oil well and down-hole pump 228. Motor 222 is a three phase permanent magnet linear electric motor having a stationary stator and a sliding shaft. Motor 222 receives power from three phase power line 234 from motor driver 124. Coupled to motor 222 is motor sensor package 224. Motor sensor package 224 includes a synchronous serial interface (SSI) encoder for sensing the position of the linear motor shaft, a temperature sensor for monitoring the motor temperature, an inclinometer for measuring the angle that the linear motor is mounted, and a circuit fault detector. Motor 222 is coupled to down-hole pump 228. Down-hole pump 228 includes a standing valve, a traveling valve, a piston or plunger, inlet 227, and outlet 231. Pump 228's piston is coupled to motor 222's shaft. As pump 228's piston is forced up and down by motor 222, oil is drawn into inlet 227, and pushed up out of outlet 231. Outlet 231 is coupled to production tubing leading to the surface of the oil well.

Inlet 227 has temperature sensor 225 for providing the temperature at the inlet and pressure sensor 226 for providing oil or fluid pressure at the inlet. The inlet pressure can be used to determine the depth of oil remaining in the oil well. Outlet 231 includes pressure sensor 229. The sensor output from inlet 227 and outlet 231 are combined into a single conductor transducer interface 239. Sensory data from motor sensor package 224 is similarly combined into a 3 twisted pair interface. The data interface may be implemented using alternative protocols for either analog or digital signal transfer.

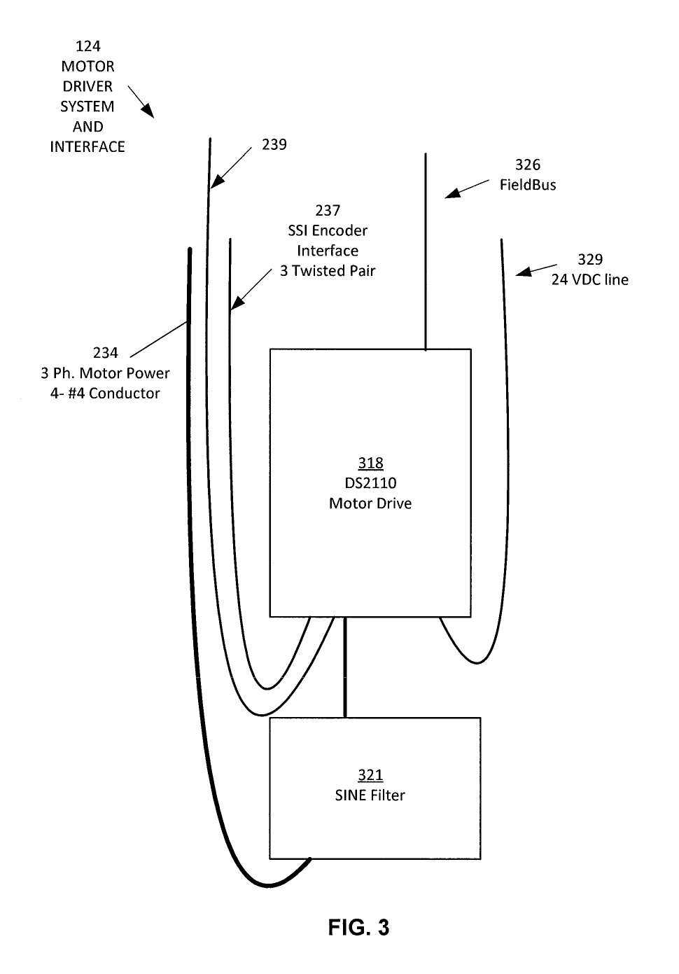

FIG. 3 is a block diagram of motor driver system and interface 124. Motor driver system 124 includes motor drive unit 318 and SINE filter 321. In this embodiment, motor drive unit 318 is a DS2110 servo drive from Moog Inc., East Aurora, N.Y., USA. However, other similar electromagnetic motor drive units may be used. Motor drive unit 318 receives sensory data lines 237 and 239. Motor drive unit 318 interfaces with control and communication computer 126 over digital interface bus 326. Sensory data from lines 237 and 239 is relayed to computer 126 over bus 326. Bus 326 is also used by computer 126 to relay drive commands to motor drive unit 318. Bus 326 has multiple protocols implemented including DeviceNet, RS485, F-NET, Modbus, FireWire, CANopen, Ethernet IP, ProfiNet, and SERCOS. However, other similar protocols may also be used as alternatives.

Motor drive unit receives high power and 24 volt DC line 329 from power distribution system 128. The 24 volt line 329 may or may not be relayed through the control and communication computer 126.

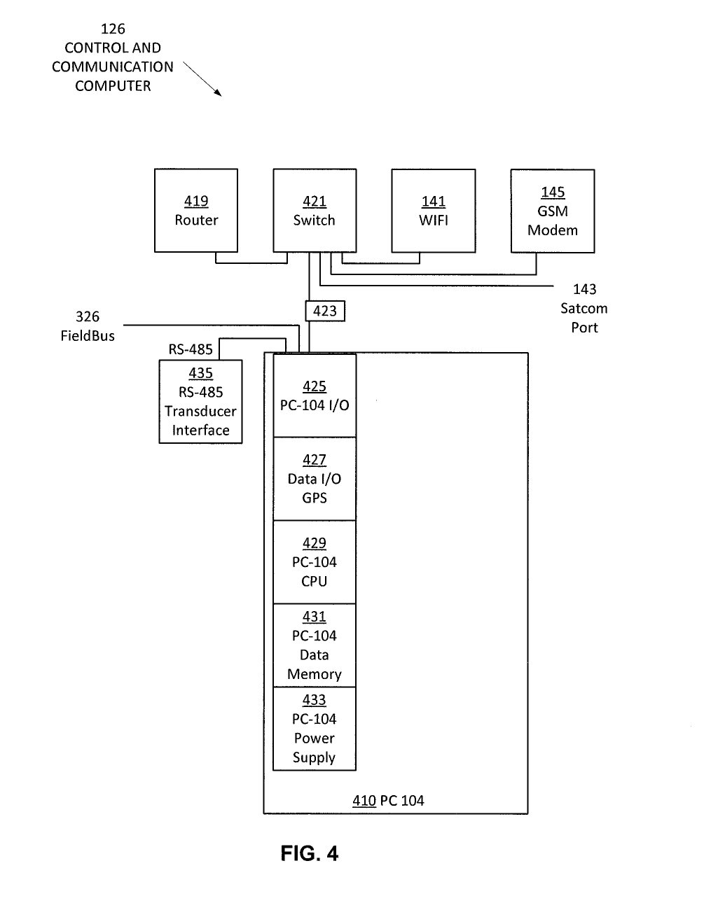

FIG. 4 is a block diagram of control and communication computer system 126. Computer system 126 includes single board computer 410, which is implemented with a PC 104 computer. However, other similar computers may be used for computer 410. Computer system 126 includes router 419, switch 421, data transceivers for wifi 141, and GSM cellular modem 145. A satcom port 143 is provided for connection to a satellite modem/antenna. Switch 421 connects router 419, wifi transceiver 141, GSM modem 145, sitcom port 143, and single board computer 410 over an Ethernet 423. Router 419, wifi transceiver 141, GSM modem 145, and satcom port 143 all provide external network connections for single board computer 410. This external network connection is primarily used for communication between single board computer 410 and data server 134.

Single board computer 410 includes I/O 425, GPS 427, CPU 429, Memory 431, and power supply 433. The Ethernet 423 connects to single board computer I/O 425. I/O 425 also interfaces with bus 326 and RS-485/RS232 transducer interface 435.

Application programs are stored in memory 431 and configured to run on CPU 429. More specifically, programs on single board computer 410 provide driver control signals to motor driver system 124, receive and record sensory data from pump 122, motor driver 124, and power distribution system 128, upload data logs to data server 134 and/or GUI computer 130, and receive configuration commands from data server 134 and/or GUI computer 130.

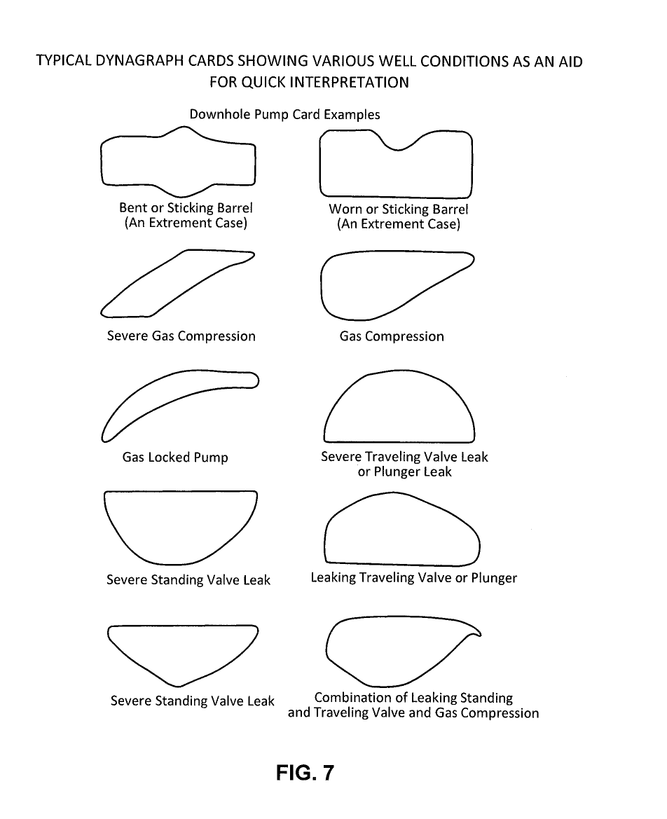

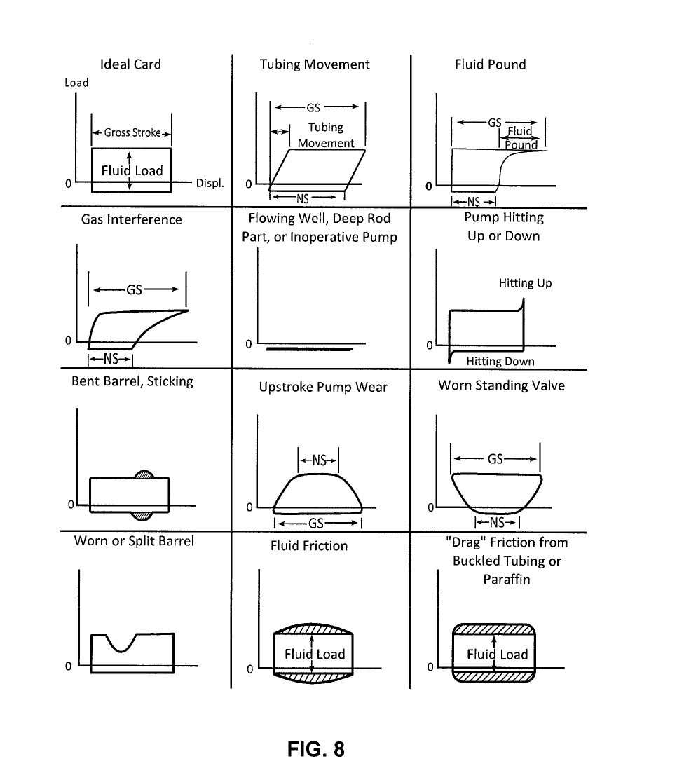

Additionally, programs on single board computer 410 may monitor the received sensory data and alter the motor drive commands sent to motor driver system 124 as a function of the received sensory data. More specifically, programs on computer 410 may recognize one of several types of operating regimes, as specified in FIGS. 7 and 8. FIGS. 7 and 8 provide motor load vs. pump displacement curves for several known operating regimes. For example, as shown in FIG. 8, the “Ideal Card” curve is a rectangular load vs displacement curve for a single upwards and downwards stroke cycle of the pump. Also, on FIG. 8, the “Pump Hitting” curve shows how the motor load spikes at the top of an upwards stroke, and/or the bottom of a downwards stroke. These curves may also be called dynamometer cards. Computer 410 is programmed to recognize each of these operating regimes, and to trigger a warning and/or adjust pump operation based upon these cards. For example, if a “Pump Hitting” curve is recognized in the sensory data, computer 410 will attempt to send a warning to data server 134, all GUI computers 130, and all remote management computers 138. Computer 410 will then adjust the drive command sent to motor driver 124 such that pump 122 is driven with a shorter stroke.

Programs on single board computer 410 further implement communication protocols for use in interacting on RS-485 transducer interface 435, the bus interface 326, or Ethernet 423. Programs on single board computer also include encryption and compression which are applied to transmissions between control and communication computer system 126 and data server 134 and/or GUI computer 130. Programs on computer 410 may also implement an FTP and telnet server. The FTP server may be used to receive and transmit files to computer 410. The telnet server may be used to provide a command terminal for viewing data stored on computer 410 or live from sensory data feeds. The telnet server command terminal may also allow control and communication computer 126's control parameters to be set.

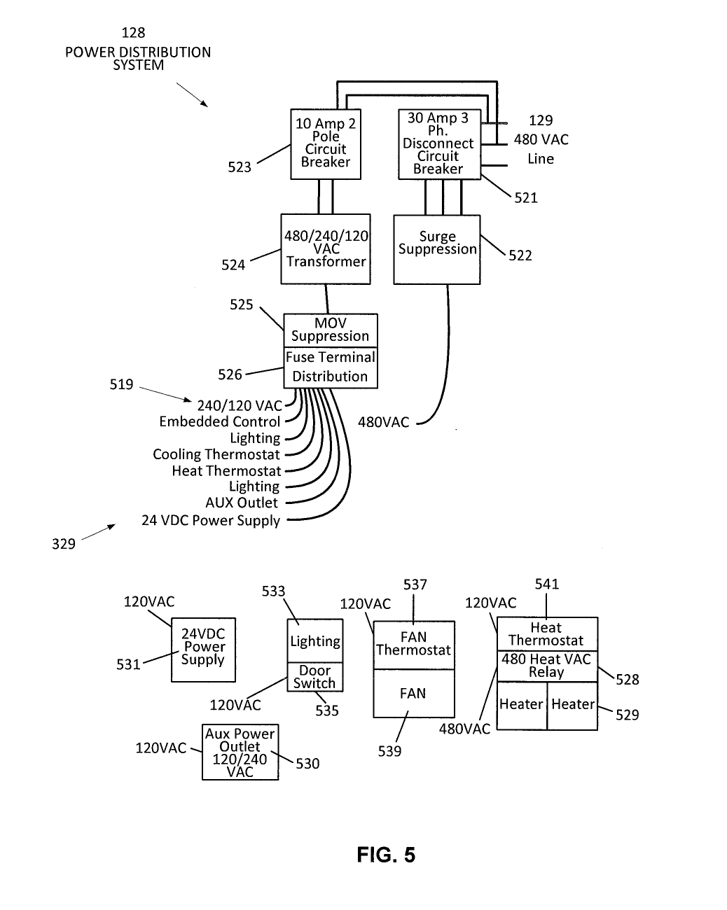

FIG. 5 is a block diagram of power distribution system 128. Power distribution system 128 receives power from AC mains 129, and provides power to system 110 via 240/120VAC line 519 and 24VDC line 329.

AC mains 129 is a 480 V three phase AC line in this embodiment. Power distribution system 128 includes circuit breaker 521 connected to the three phases of AC mains 129. In this embodiment, circuit breaker 521 is a 30 amp three phase disconnect circuit breaker. Circuit breaker 521 passes the three phase power through surge suppression unit 522, which then makes the 480VAC signal available to the rest of pump operation system 110. Two of the phases from AC mains 129 is provided to two pole circuit breaker 523. Circuit breaker 523 is a 10 amp breaker. Circuit breaker 523 provides two phase AC power to transformer 524. Transformer 524 is a 480/240/120 VAC transformer. The outputs of transformer 524 is passed through MOV suppression unit 525 before reaching fuse terminal distribution block 526. Terminal distribution block 526 provides the connection terminal for several electrical power output circuits, including 240/120 VAC output line 519, and 24VDC power supply line 329. The 120VAC line is provided to power converter 531 which converts 120VAC to 24VDC. 24VDC may come directly from 3 ph 480 VAC. The 120VAC line is further used to provide power to lighting 533, door switch 535, cooling thermostat 537, cooling fan 539, and heat thermostat 541. The 480 volt surge suppressed line is used to provide power to heat relay 528 and heaters 529.

Cooling and heating thermostats 537, 541, fan or AC unit 539, and heaters 529 are used to keep the environment in box 125 within a desired temperature range.

GUI computer 130 is a computer with a display, keyboard, and a network modem (NIC). The network modem is used to connect GUI computer 130 to the LAN provided by control and communication computer 126. GUI computer 130 includes software application 131. Software application 131 provides user 101 an interface for connecting to control and communication computer 126 for the purpose of viewing live and stored sensor data, and for viewing and setting control parameters of control and communication computer 126. Software application 131 will further provide a graphical geographic view of known pumps, as well as provide basic operation statistics for each of the known pumps. Software application 131 may be a web browser, a telnet client, or, as in this embodiment, a custom software application.

After user 101 connects GUI computer 130 to control and communication computer 126's LAN, user 101 then starts application 131. Application 131 queries user 101 for a username and password, which are then provided to control and communication computer 126 for authentication. After authentication, application 131 provides user 101 several options. User 101 may select an option to view the current sensory data of pump control system 110. This causes application 131 to request a data stream from control and communication computer 126. Each of the raw sensor signals collected by control and communication computer 126 are forwarded to application 131 including motor output force, motor position, motor temperature, pump inlet and outlet pressure, inlet temperature, pump inclination, motor driver state, motor driver output current, power distribution system state and temperature, and power distribution system output voltage and current. This data is constantly streamed from control computer 126 to application 131, and is ideally updated on the GUI computer display in realtime. Application 131 may process the received data and may place the data into a graphical display. For example, the pump displacement and motor force output may be plotted in y vs x fashion in order to display data in the same format as the dyna card plots in FIG. 7 and FIG. 8.

User 101 may also select to view historical sensory data saved by control computer 126. For example, application 131 may request from control computer 126 the sensory data from the last 1000 pump cycles. Upon receiving this data, application 131 may display this data in the form a plots with a time axis. For example, pump displacement vs motor force output could be plot as a 3D plot with a third axis for time (or pump cycle number). A color code can be applied to show a transition in the wear of the system, such as green for a “new” motor/pump to “red” which would indicate high wear and actual damage resulting in failure, thus requiring replacement. Further, the data viewed may be time averaged data based upon some time period. For example, each data point may be the average for a given data. More specifically, if user 101 is viewing the inlet temperature, application 131 may calculate and plot the average temperature for each day, such that the average temperature over a given day produces a single data point, and all the datapoints over a given time period are plotted with the day as the x axis variable and temperature as the y axis variable. Further, software application 131 may be used to display a warning to user 101 which is generated by a program running on control computer 126. For example, if a program on control computer 126 recognizes that the motor force vs. pump displacement data produces a curve similar to one of the error conditions shown in FIG. 7 or 8, a descriptive warning may be flashed on GUI computer 130's display.

Software application 131 may also be used to adjust the operating parameters of control computer 126. For example, after viewing sensory data, user 101 may decide that the pump should be operating at a decreased frequency. Application 131 provides user 101 with a command interface in order to set a new operating frequency. More specifically, application 131 allows user 101 to specify the exact movement profile that pump system 122 is to be driven at. The movement profile may be a distance vs time curve, or a force vs time curve for a given operation cycle of the pump.

Application 131 may further allow user 101 to program the operating function that control computer 126 is to follow based upon sensory data. For example, user 101 may program control computer 126 to set the pump frequency to be equal to the inlet pressure times a constant. Other, more complex functions may be used to define the movement profile that control computer 126 is to command motor driver 124 based upon a whole range of sensory input conditions. For example, control computer 126 may be programmed to automatically adjust the movement profile based upon predefined conditions, such as the operating regimes defined in FIGS. 7 and 8. The movement profile may be different for a downstroke and upstroke, and may vary the frequency in realtime. User 101 may further set thresholds for defining when warnings should be generated by control computer 126.

Data server 134 provides the functionality of GUI computer 130 to many potential remote users 102, as well as acts as a data storage and backup facility. Data server 134 also acts as a mechanism to provide periodic data to control and communication computer 126 which may affect the operating function of control computer 126.

All of the functionality provided by application 131 is also available through web application 136 running on data server 134. However, due to the higher latency expected between data server 134 and control computer 126, some of the real-time functionality may not be available. Web application is designed to act as a server core a client remote management computer 138. A user 102 may connect to web application 136 by using a standard web browser on remote management computer 138. In addition to be able to view the data stored on control computer 126, web application 136 provides the ability to view data stored on data server 134.

It may be advantageous to back up sensory data logs from control computer 126 to data server 134. For example, control computer 126 may send daily data logs to data server 134. This allows redundant data to be deleted from control and communication computer 126, such that a smaller data storage may be implemented on control computer 126. Also, by having the sensory data stored on data server 134, historical data may be provided to multiple remote users over a faster and cheaper network link then would be possible if each remote user had to connect to the control and communication computer 126 themselves (i.e. satcom is typically slower and more costly than generic internet access). Also, by having data server 134 provide data to remote users 102, the processing demand on control computer 126 is reduced.

Data server 134 may also be used to provide periodic data to control computer 126 which is relevant to the method of pump operation. For example, the international oil price may be obtained by data server 134 and provided to control computer 126. Control computer 126 may use the oil price as a variable in determining the operating parameters. For example, if the oil price is low, it may be more appropriate to operate the pump at a lower frequency to provide higher efficiency and less wear. However, if the oil prices has significantly increased, it may be advantageous to increase pump frequency in order to capitalize on selling more oil at the high price even at the cost of having increased pump wear. Many other variables may be periodically provided by data server 134 to control computer 126 such as electricity cost, weather conditions, predicted demand, shipping delays, maintenance schedules, and/or pipeline downtime schedules. Each of these variables would be appropriately incorporated into the operating algorithm on control computer 126.

The disclosed system and methods resulted in a number os surprising results and advantages. The disclosed system and methods allow for a health and usage monitoring system that is predictive and proactive instead of reactive in nature. Advanced warning can be given to technicians such that they can proactively take measures to correct the motor or pump performance before the motor or pump fails. This can save millions of dollars in maintenance costs and support.

This system can also measure and track trends such as rate of pump wear or variance in current vs. pressure to determine health and life of the system and predict maintenance intervals. The color coded scheme of displaying dyna card data, combined with the 3D representation of the data allows operators and technicians to quickly and easily see where/when a particular system entered into a failure state, or whether the system is in a high wear or low wear state. Further, this system allows greater accuracy in determining down-hole conditions and provides a greater degree of automated control than is available in prior art systems.

The disclosed system provides for remote monitoring and control via various redundant communications channels including internet, wifi, cellular data and/or satcom. Further, a GPS system embedded in the control system will automatically locate and map the well for a remote management system.

Therefore, while the presently-preferred form of the down-hole pump control system has been shown and described, and several modifications discussed, persons skilled in this art will readily appreciate that various additional changes may be made without departing from the scope of the invention.

1. A downhole linear motor pump system comprising:
a downhole linear electric motor having a stator and a shaft configured to move linearly relative to said stator;
a downhole pump having an inlet, an outlet, and a piston coupled to said downhole linear motor shaft;
a motor driver system connected with said downhole linear motor and configured to provide drive commands to said downhole linear motor;
a surface control computer connected with said motor drive system and configured to control said downhole linear motor;
a sensor system communicating with said control computer and configured to sense operating parameters of said downhole linear motor; and
said sensor system comprising a downhole synchronous serial interface encoder configured to sense position of said motor shaft and a downhole temperature sensor configured to sense the temperature of said motor.

2. The system set forth in claim 1, wherein said sensor system further comprises a pump inlet pressure sensor and a pump inlet temperature sensor.

3. The system set forth in claim 1, wherein said sensor system further comprises a current sensor configured to sense motor driver output current and said control computer is programmed to determine motor output force from said motor driver output current.

4. The system set forth in claim 3, wherein said control computer is programmed to provide an output command as a function of one or more of said operating parameters from said sensor system.

5. The system set forth in claim 4, wherein said output command is a function of motor shaft position and motor output force.

6. The system set forth in claim 1, wherein said sensor system further comprises a downhole inclinometer configured and arranged to sense the inclination of said motor shaft

7. The system set forth in claim 1, and further comprising a surface power distribution system configured and arranged to provide power to said control computer and said downhole linear motor, and wherein said power distribution system and said surface control computer are contained in an environmentally protected cabinet.

8. The system set forth in claim 7, wherein said sensor system provides power distribution system input voltage and power distribution system input current.

9. The system set forth in claim 8, wherein said control computer is programmed to determine pump efficiency from said power distribution system input voltage and power distribution system input current.

10. A downhole linear motor pump system comprising:
a downhole linear electric motor having a stator and a shaft configured to move linearly relative to said stator;
a downhole pump having an inlet, an outlet, and a piston coupled to said downhole linear motor shaft;
a motor driver system connected with said downhole linear motor and configured to provide drive commands to said downhole linear motor;
a surface control computer connected with said motor drive system and configured to control said downhole linear motor;
a sensor system communicating with said control computer and configured to sense operating parameters of said downhole linear motor;
said sensor system comprising a downhole position sensor configured to sense position of said motor shaft, a downhole pump inlet pressure sensor, and a current sensor configured to sense motor driver output current; and
said control computer programmed to determine motor output force from said motor driver output current.

11. The system set forth in claim 10, wherein said control computer is programmed to provide an output command as a function of one or more of said operating parameters from said sensor system.

12. The system set forth in claim 11, wherein said output command is a motor drive command.

13. The system set forth in claim 12, wherein said motor drive command is a function of a change in pressure sensed by said pump inlet pressure sensor.

14. The system set forth in claim 11, wherein said output command is a diagnostic indication of system wear or malfunction.

15. The system set forth in claim 14, wherein said control computer is programmed to generate one or more pump displacement versus motor output force operating profiles based on said motor shaft position and said motor driver output current.

16. The system set forth in claim 15, wherein said control computer is programmed to recognize one or more pump displacement versus motor output force reference standard operating profiles.

17. The system set forth in claim 16, wherein said one or more reference standard operating profiles are selected from a group consisting of bent or sticking barrel, worn or sticking barrel, gas compression, severe gas compression or interference, gas locked pump, traveling valve leak or upstroke pump wear, standing valve leak or worn standing valve, combination of leaking standing and traveling valve and gas compression, tubing movement, inoperative pump, pump hitting, fluid friction and drag friction.

18. The system set forth in claim 11, wherein said output command comprises a motor shaft movement operating profile.

19. The system set forth in claim 18, wherein said motor shaft movement operating profile comprises position versus time or motor output force versus time.

20. The system set forth in claim 10, wherein said control computer is programmed to provide a user signal as a function of one or more operating parameters from said sensor system.

21. The system set forth in claim 20, wherein said user signal is a warning signal or a graphical display.

22. The system set forth in claim 21, wherein said graphical display comprises a three-dimensional plot.

23. The system set forth in claim 22, wherein said three-dimensional plot comprises pump displacement versus motor output force versus time or pump cycle.

24. The system set forth in claim 20, wherein said graphical display comprises a pump displacement versus motor output force operating profile.

25. The system set forth in claim 20, wherein said sensor system further comprises a pump outlet pressure sensor and said graphical display comprises motor driver output current versus pump outlet pressure.

26. The system set forth in claim 11, wherein said sensor system further comprises a pump outlet pressure sensor and said output command is a function of pressure sensed by said pump outlet pressure sensor and said motor driver output current.

27. The system set forth in claim 10, and further comprising a remote computer system in communication with said control computer via the internet.

28. The system set forth in claim 27, wherein said remote computer system comprises a graphic user interface configured and arranged to allow a user to view data derived from said sensor system and to view and set operating parameters for said control computer.

29. The system set forth in claim 27, wherein said remote computer system comprises a data server and said data server comprises a database for storing data from said control computer.

30. The system set forth in claim 10, wherein said control computer comprises a memory unit.
